(19) United States
(12) Patent Application Publication
(10) Pub. No.: US 2025/0389828 A1
(43) Pub. Date: Dec. 25, 2025

(54) SENSOR WITH SCANNING UNIT AND WINDOW MONITORING UNIT

(71) Applicant: BEA SA, Angleur (BE)

(72) Inventors: Julie KLESPERT, Liège (BE); Christian LEPRINCE, Sprimont (BE); Sébastien VAN LOO, Vaux-et-Borset (BE); Antoine DEJONG, Nessonvaux (BE)

(21) Appl. No.: 18/879,238

(22) PCT Filed: Jun. 28, 2023
(86) PCT No.: PCT/EP2023/067737

§ 371 Date: Dec. 26, 2024

(30) Foreign Application Priority Data
Jun. 28, 2022 (DE) 10 2022 116 100.5

(51) Int. Cl. G01S 7/497; G01S 7/481

(52) U.S. Cl. CPC G01S 7/497; G01S 7/4813; G01S 7/4817; G01S 2007/4975

(57) ABSTRACT

A sensor comprises a housing comprising a window that extends over angular detection range and scanning-light passes therethrough, a scanning unit inside housing to scan angular detection range by emitting and receiving scanning-light with a rotating mirror to deflect scanning-light. A window monitoring unit detects pollution on window comprising at least a first and second opto-electronic components to establish a test-light path therebetween and attached to housing. The test-light path passes through the window. The window monitoring unit comprises an optical component to redirect the test-light, the opto-electronic components and optical component are arranged where a plurality of test-light paths are generated along angular detection range. The optical component is a lightguide that guides the test-light between first and second opto-electronic components and is attached to and rotate together with rotating mirror so that test-light paths of different angular positions end at at least one same second opto-electronic component.

The invention relates to a sensor according to the preamble of claim 1.

Generic sensors are used to determine objects within their scanning fields. Such sensors comprise a housing for the scanning unit where the scanning-light is sent through a window of the sensor. Such sensors, especially in outdoor applications, are subjected to environmental impacts such as snow, rain and dirt. Due to these environmental impacts the transparency or translucency of the sensor's window may be influenced in a way that the scanning-light may be prevented from leaving the sensor or the reflected light may be prevented from entering the sensor.

To address this problem, sensors are already known that comprise arrangements to test the transparency of the sensor's windows.

DE 10 2015 105 264 A1 discloses an opto-electronic sensor that comprises a test-light scanner, where the test-light scanner comprises a test-light deflector that rotates together with the deflection means of the scanning unit. Test-light emitters and test-light receivers are distributed around the circumference of the housing.

Accordingly, the test-light receivers and test-light emitters are placed next to each other in a radial direction. The emitted light travels through the window and is reflected by the test-light deflector which is attached to the rotating deflection means. This setup allows the path through the window to be analyzed. The received intensity of the beam can be used to determine the soiling of the window.

EP 2 237 065 A1 discloses a test-light arrangement for checking the window of a sensor. The measurement radiation is deflected by a rotating mirror. The receiver and the LED of the test-light arrangement are in a fixed position relative to the mirror on the same side of the mirror. The test-light that is emitted by the LED is reflected by a mirror which is fixed to the housing and which is placed opposite to the test-light emitter and test-light receiver. This arrangement allows a continuous measurement along the circumference of the window.

This arrangement has the drawback that the electric components are arranged on a rotating part, namely the mirror, whereas the circuit boards are usually attached to the fixed part of the housing. Depending on the size of the rotating mirror, the diodes attached to the mirror may have a negative influence on the balance of the rotating mirror element.

It is the object of the invention to provide an improved window monitoring system.

The object is solved by the characterizing features of claim 1 in combination with the features of its preamble.

The subclaims are further advantageous embodiments of the invention.

In a known way, a generic sensor comprises a housing and a scanning unit that is placed inside said housing to scan an angular detection range by emitting and receiving the scanning-light. The scanning unit comprises a rotating mirror to deflect the emitted and/or the received scanning-light. By rotation of the rotating mirror the scanning-light sweeps the angular detection range preferably in multiple planes. For example, the scanning unit can comprise a LiDAR system, where the scanning-light is preferably pulsed and a distance is determined by evaluating the time-of-flight of the pulse and its reflection, which is commonly known as TOF evaluation.

The housing includes a window through which the scanning-light can pass. Said window extends circumferentially over the said angular detection range and in a direction parallel to the axis of rotation of the rotating mirror where the at least one window element can be inclined relative to the axis of rotation. A window in the context of the invention is a part of the housing that is transparent for the scanning-light to pass through. The transparency of the window is also given for the test light.

Furthermore, the sensor comprises a window monitoring unit to determine the transparency of the window. Said window monitoring unit comprises a first opto-electronic component and a second opto-electronic component between which a test-light path can be generated by sending a test-light from the first opto-electronic component to a second opto-electronic component or vice versa.

The at least one test-light path is generated in a way that the test-light passes through the window. The part of the test-light path passing through the window is oblique to the path of the scanning-light, preferably almost perpendicular.

The at least one first opto-electronic component and the at least one second opto-electronic component are attached to the housing.

Furthermore, the window monitoring unit comprises an optical component through which the test-light is redirected between the first opto-electronic component and the second opto-electronic component. Furthermore, the window monitoring unit comprises an evaluation unit that is embodied to evaluate the variation in power of the received test-light to determine if a significant degree of dirt or the like is present on the window and its transparency is significantly reduced.

The optical component, the at least one first opto-electronic component and the at least one second opto-electronic component are arranged in a way that a plurality of test-light paths is established along the angular detection range of the scanning unit.

According to the invention, the optical component is a lightguide that directs the test-light over a part of its test-light path. The lightguide is attached to the rotating mirror in a way that it rotates together with the mirror and allows different test-light paths at different angular positions of the window to be led to the same second opto-electronic component. Accordingly, multiple test-light paths end in a common end point, especially having a fixed position.

According to this setup a plurality of test-light paths can have a very high resolution of angular positions simply by attaching a lightguide to the rotating mirror, as the resolution is not dependent on the size of the opto-electronic components but on the size of the lightguide.

The lightguide is preferably a small piece of plastic that only has a minor or insignificant influence on the balance of the mirror regarding the mirror's rotational properties. In addition, neither the power supply nor any kind of signal transfer of an opto-electronic component needs to be facilitated between rotating electrical components and circuit boards attached to the housing. Using the effect of total internal reflection (TIR), the lightguide directs light from a first end having a first coupling structure that couples light from or to a first opto-electronic component, to a second end having a second coupling structure that couples light from or to a second opto-electronic component.

Light from the at least one opto-electronic component is introduced into the lightguide within the correct range of angles and becomes trapped inside the lightguide and remains mainly inside the lightguide until it is extracted by an extraction feature or encounters a surface at less than the critical angle and is then led to the at least one receiving opto-electronic component.

In a further embodiment, the lightguide is preferably made of plastic, particularly a polycarbonate. The plastic may, typically, have an index of refraction around 1,5.

According to a preferred embodiment the window monitoring unit comprises a plurality of first opto-electronic components and one second opto-electronic component to establish a plurality of test-light paths.

Due to this arrangement each of the plurality of first opto-electronic components can establish a plurality of test-light paths with the second opto-electronic component depending on the angular position of the lightguide.

In the case that the first opto-electronic components are emitters, they can be operated in a pulsed mode and each pulse of the same emitter may establish a different test-light path due to the different angular positions of the lightguide at the time of the pulse.

According to a further improvement of the invention the second coupling structure of the lightguide lies at the center of rotation of the rotating mirror to couple or decouple light of different light-paths to the second opto-electronic component. Due to this arrangement the angular positions of a full rotation of the mirror can be covered by a single second opto-electronic component.

Preferably the second opto-electronic component is positioned in alignment with the center of rotation of the rotating mirror and faces the second coupling structure of the lightguide. According to this arrangement, the test-light can be directed directly to the second opto-electronic component.

According to an alternative solution, the window monitoring unit may comprise an additional lightguide to guide the light from the center of rotation to the second opto-electronic component. In this arrangement the first coupling structure of the additional lightguide is positioned in alignment with the axis of rotation of the rotating mirror. According to this embodiment the first opto-electronic component and the second opto-electronic component can both be mounted on the same circuit board.

In the case that the second opto-electronic component is a receiver, the test-light coupled into the lightguide is decoupled at the center of rotation of the rotating mirror and shines on the receiver. Thus, the test-light decoupled from the lightguide illuminates the receiver and the test- light can potentially be received continuously over the entire angular detection range, during rotation of the mirror.

In a very preferred embodiment, the lightguide is a fiber or a prism that extends from the center of rotation in radial direction. A fiber, channel or prism is very light and has low impact on the balance of the mirror. Furthermore, a fiber, channel or a prism has a defined size (cross-section), so that the coupling structure can be an inclined surface directed to the first opto-electronic component, so that the position of the test-light path can easily be determined depending on the angular position of the rotating mirror.

If the lightguide is a prism, the coupling structure can be stablished by an inclined surface.

In a further preferred embodiment, the second opto-electronic component is a receiver, especially a photodiode. As receivers usually take up more space than LED-Emitters, an improved spatial resolution can be achieved. Emitters and receivers preferably emit and receive an infrared radiation.

According to an advantageous embodiment, the window monitoring unit comprises a plurality of first opto-electronic components being emitters, namely LEDs distributed over the angular detection range especially following the window contour.

In a more preferred embodiment said window monitoring unit may comprise a shielding that surrounds a plurality of first opto-electronic components where the shielding comprises a conical cavity around each of the plurality of the first opto-electronic components. This gives a defined shape to the emitted light, so that the established test-light paths are very defined, especially effecting a defined opening angle of the conically shaped test-light beam.

According to a further embodiment of the invention there is at least one lens between the at least one first opto-electronic component and the lightguide, where the lens is embodied as a converging lens with a focal point at the side of the first opto-electronic component.

This has the effect that the border of the light beam, at least in one cross-sectional plane including the rotation axis, has a very acute angle, between the lens and the lightguide.

This allows an almost parallel transmission of the test-light through the window elements.

Preferably the lens comprises a convex-curved cross-section in at least one cross-sectional plane including the rotation axis. More preferably, the lens has, as viewed in the plane that is normal to the rotation axis, a curved shape, particularly the shape of a circle or a sector of a circle and stretches over at least a part of the angular detection range (alpha). Consequently, each lens has a plurality of focal points distributed along the circumference of the sector or the circle.

The window monitoring unit can comprise a circular mirror at the same height as the lightguide. Said circular mirror deflects the test-light from the first opto-electronic component to the lightguide or vice versa. According to this embodiment the lightguide does not need to have its first coupling structure directed to the first opto-electronic component in the light direction but can have it arranged transversely to it, especially perpendicular to it. As a result of employing the circular mirror the lightguide can have an extension that can equal the radius of the mirror or can be less than the radius. This improves the balance of the rotating mirror compared to a lightguide which extends beyond the rotating mirror's circumference.

In addition, the circular mirror may increase the amount of energy that can be transmitted via a test-light path in case the first coupling structure of the lightguide and the active first opto-electronic component have a different angular position. Within the meaning of the invention, an opto-electronic component is rendered active in case of a receiver during measuring and in case of an emitter during emitting.

The circular mirror enhances the number of possible test-light paths having a sufficient intensity, as the number of test-light paths is not only limited to test-light paths, where the first and the second opto-electronic component lie in the same angular extension, but also include additional test-light paths that comprise an angular offset. This can effectively increase the resolution of the window monitoring unit without needing additional opto-electronic components.

According to a further embodiment of the invention, the window comprises two window elements which, when viewed along the direction of the axis of rotation, are arranged one above the other and are inclined towards each other. Preferably the two window elements are optically separated in that one window element is penetrated by the emitted scanning-light whereas the other window is penetrated by the reflected scanning-light.

The window monitoring unit is embodied in a way that the test-light paths pass through both window elements.

The window monitoring unit is preferably embodied in a way to acquire test-light along the test-light paths of which at least a first test-light path is defined in such a way that it has a first offset between its angular position of the lightguide and the active first opto-electronic component, and at least a second test-light path is defined in such a way that it has a second offset between its angular position of the lightguide and another active first opto-electronic component, where the second offset differs from the first offset by a defined lateral offset distance and/or in a lateral offset direction. According to this evaluation the vertical resolution can be improved, especially in the case that the light paths are generated in a meshed topology.

More preferably the lateral offset distance is more than ⅛th, particularly more than ¼ of the window height extension allowing a sufficient difference inclination to allow a vertical determination of a spot on the window.

According to a further advantageous embodiment, the window monitoring unit is designed to acquire intensities of crossing light paths. Crossing test-light paths are generated if the position of the first active opto-electronic component of a second light path comprises an offset to a first active opto-electronic of a first test-light path in a first offset direction and the first angular position of the lightguide of a first test-light path and the second angular position of the light-guide of the second test-light path have an offset in a second offset direction that is opposite to the first offset direction.

Such a mesh of test-light paths established in this way allows an improved determination of the position and size of spots polluting the window. This improved determination of spots on the window allows the behaviour of the scanning unit to be influenced in a more differentiated manner.

The invention furthermore refers to a method to determine the transparency of a window of a sensor as previously described, where the sensor comprises a first window element and a second window element and an evaluation unit. The angular position of the lightguide and the activation of the first opto-electronic component and/or the second opto-electronic component are synchronized in a way that an optical mesh of test-light paths is established. The optical mesh is evaluated based on the measured intensities related to the test-light paths. A change of transparency of the window is determined to be on the first window element and/or the second window element.

The optical mesh within the scope of the invention can particularly be established by subsequently generating the specific light paths one at a time.

Throughout the description, the claims and the drawings, those terms and associated reference signs are used as they appear in the enclosed list of reference signs. The drawings show

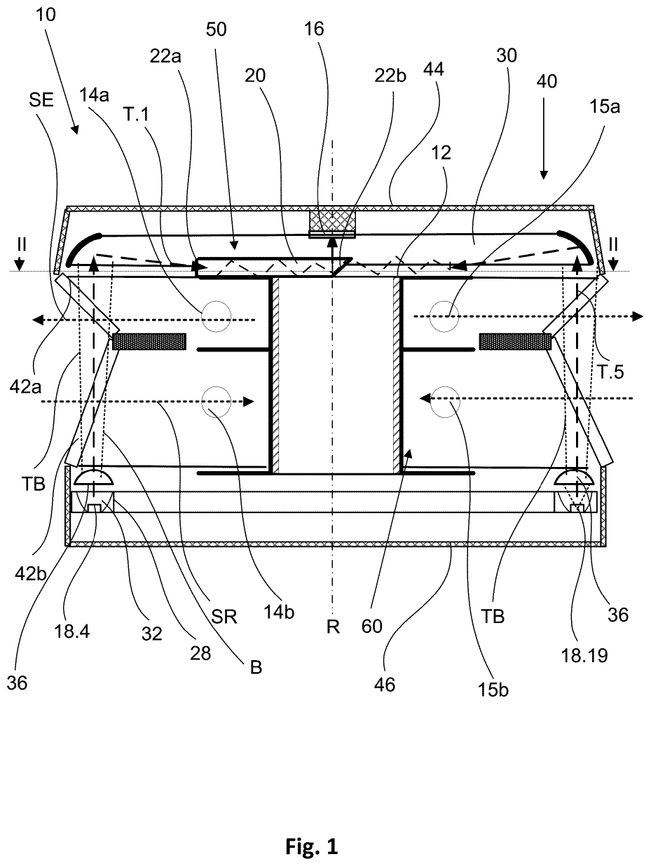

FIG. 1 a cross-sectional view of an embodiment of the sensor according to the invention;

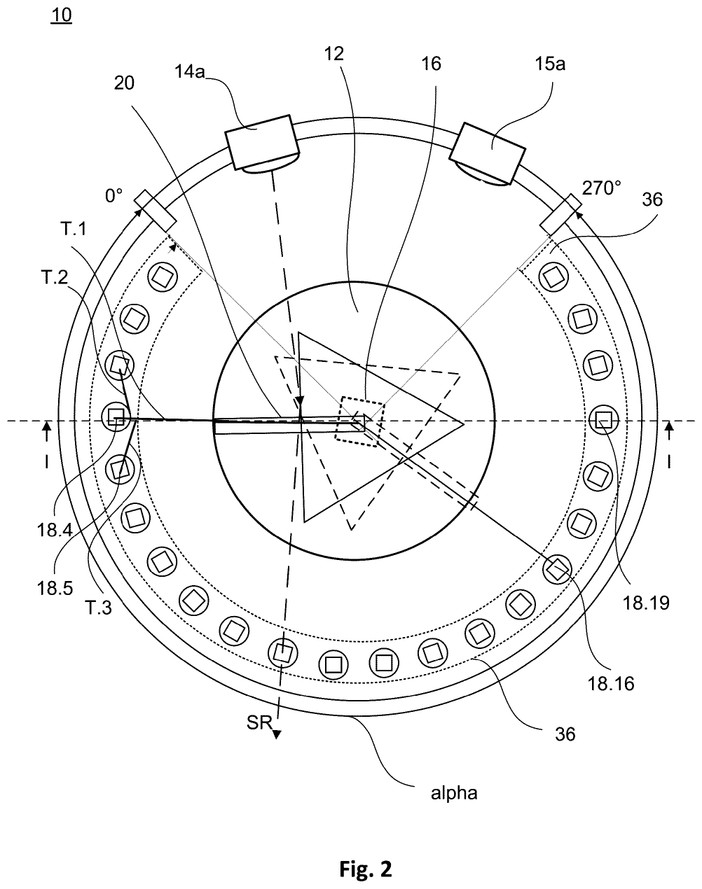

FIG. 2 a different cross-sectional view of the sensor in FIG. 1;

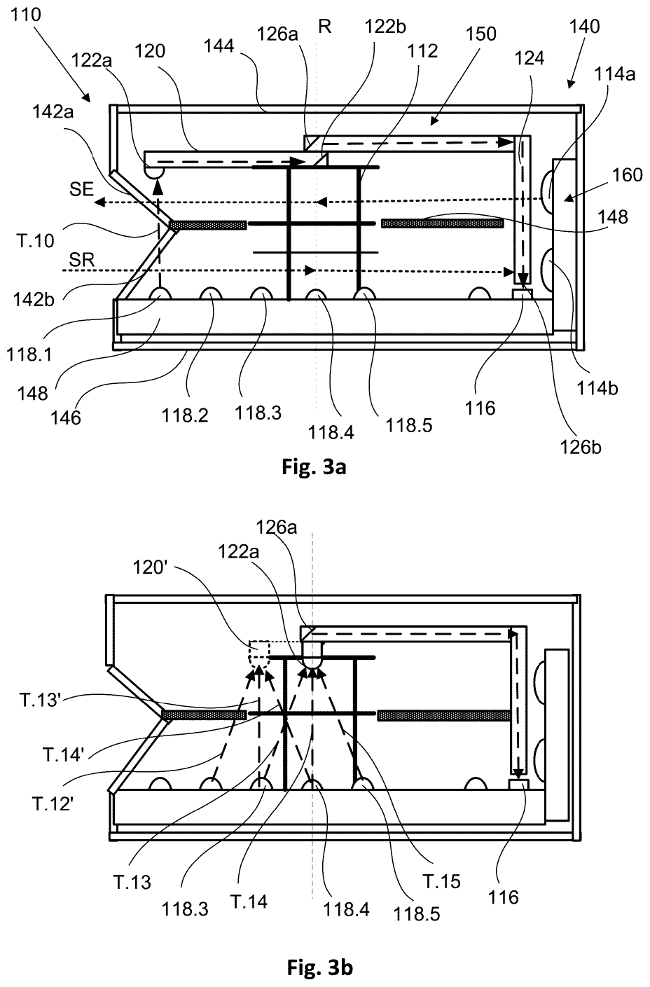

FIG. 3a an alternative embodiment of a sensor according to the invention in a schematic side view;

FIG. 3b a sensor according to FIG. 3a with a different angular position of the mirror, and

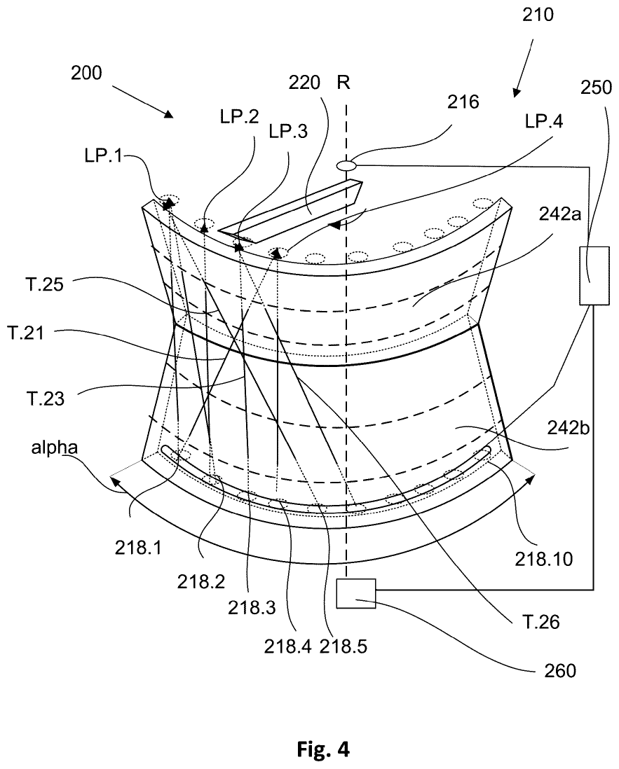

FIG. 4 shows a schematic partial perspective view of a sensor, especially its window and components of its window monitoring unit.

FIG. 1 shows a schematic cross-sectional view I-I of an embodiment of a sensor 10 according to the invention. The sensor 10 comprises a housing 40 having a top cover 44, a lower cover 46 and a window having a first window element 42a and a second window element 42b that are inclined relative to each other. The sensor 10 comprises a scanning unit 60 that comprises a scanning-light emitter 14a, 15a, a scanning-light receiver 14b, 15b and a rotating mirror 12 to scan the environment over a given angular detection range. As can be seen in the schematic cross-sectional view according to II-II in FIG. 2, the angular detection range in this embodiment is about 270°.

Referring to FIG. 1 the sensor 10 comprises a window monitoring unit 50 comprising a plurality of first opto-electronic components 18.1 to 18.22 which are embodied as infrared LEDs. The first opto-electronic components 18.1 to 18.22 are each surrounded by a shielding 28 comprising a conical cavity 32 which acts as a beam shaping cavity to give the light emitted by the first opto-electronic components 18.X a defined shape, especially a defined opening angle of a conically shaped test-light beam.

Furthermore, the window monitoring unit 50 comprises a second opto-electronic component 16 that is embodied as a photodiode. The second opto-electronic component 16 is aligned with the rotation axis R of the rotating mirror 12 and fixed to the housing 40. Since the second opto-electronic component 16 does not move during operation of the sensor 10, it can easily be electrically connected to be measured by the sensor electronics (not shown).

As can be seen in FIG. 2, the first opto-electronic components 18.1 to 18.22 are distributed around the circumference of the window elements 42a, 42b along the angular detection range alpha. The first opto-electronic components 18.1 to 18.22 emit a light beam that passes through the first window 42a as well as the second window 42b generating the test-light paths T.X.

According to the invention, the window monitoring unit 50 comprises a lightguide 20 that is attached to the rotating mirror 12 in a way that it moves, especially rotates, together with the rotating mirror 12. The lightguide 20 in this embodiment is a prism made of plastic that has a first coupling structure 22a and a second coupling structure 22b. The lightguide 20 is embodied in a way that the first coupling structure 22a lies in a radial direction of the rotating mirror 12. This means that light hitting the lightguide 20 in a direction basically perpendicular to the rotation axis R is coupled into the lightguide 20 and directed to the second coupling structure 22b. The lightguide 20 is embodied in a way that the second coupling structure 22b decouples the light in a direction parallel to the rotation axis R.

According to this embodiment, the second opto-electronic component 16 is mounted aligned to the rotation axis R, so that the light that is decoupled from the lightguide 20 at the second coupling structure 22b is directly led to the second opto-electronic component 16.

According to this arrangement the lightguide 20 may receive test-light at all angular positions depending on a current rotation angle of the rotating mirror 12.

The first opto-electronic components 18.X are arranged in a way that the test-light basically travels parallel to the rotation axis R.

Furthermore, the window monitoring unit 50 comprises a circular mirror 30 to deflect the test-light to be received by the lightguide 20 in radial direction. The circular mirror 30 basically redirects the test-light from an axial to a radial direction. Additionally, due to its circularity the circular mirror 30 focuses the test-light having a path which is not parallel to the rotation axis R but oblique thereto. This makes use of the phenomenon that the test-light is not emitted as a circular beam, but conically.

FIG. 1 shows that the test-light emitted from the first opto-electronic component 18.4 follows the path T.1. In this situation, the test-light is emitted from the first opto-electronic component 18.4, passes through the second window element 42b and then through the first window element 42a. After passing through the window elements 42a, 42b, the test-light is deflected by the circular mirror 30 from an axial to a radial direction.

In the situation shown in FIG. 1, the rotating mirror 12 is in a position where the lightguide 20 is at the same angular position as is the first opto-electronic component 18.4. The test-light that is redirected to a basically radial direction hits the first coupling structure 22a basically perpendicularly. The test-light is trapped in the lightguide 20 and led along the lightguide 20 to its second coupling structure 22b at the center of rotation of the rotating mirror 12. There, the test-light is extracted from the lightguide 20 and led directly to the second opto-electronic component 16, being a photodiode that is positioned in alignment with the center of rotation of the rotating mirror 12. The second opto-electronic component 16 is positioned above the rotating mirror 12 where the light sensitive face of the second opto-electronic component 16 faces the rotating mirror.

FIG. 1 also shows the test-light path T5 received by the lightguide 20 and then by the second opto-electronic component 16 when rotating the rotating mirror by 180°.

As FIG. 1 furthermore shows, the sensor 10 may optionally comprise a convex lens 36 that has preferably, as seen from the top, a ring like shape and stretches over a sector covering all the first opto-electronic components 18.X. The lens 36 is a converging lens that has its focal point on the side and close to the first opto-electronic component. Hence the lens is, as can be seen in the cross-sectional view, convex-curved. This e.g., allows a reduction of the angle of the test-light beam which is emitted from the lens and protrudes through the inclined window elements 42a, 42b. This allows a good coverage of the whole depth of the inclined window-elements 42a, 42b.

FIG. 2 shows a schematic cross-sectional view through the sensor along II-II. The rotating mirror 12 comprises a circular top surface, where the facets of the mirror 12 are arranged in a triangular cross section.

The embodiment of the rotating mirror 12 allows an angular scanning range alpha of about 270°. The lightguide 20 extends from the center of rotation to the circumference of the rotating mirror 12. The lightguide 20 does not exceed the body of the rotating mirror 12. This arrangement has a positive influence on the balance of the rotating mirror 12.

The position of the second opto-electronic component 16 is indicated by the dashed square aligned with the rotation axis R. The test-light emitted from the first opto-electronic component 18.X can be received at various angular positions reachable by the first coupling structure 22a.

It is obvious that the number of light-paths which can be analyzed corresponds at least to the number of first opto-electronic components 18.X as the lightguide 20 passes all first opto-electronic components 18.X at a full rotation of the rotating mirror 12. For each angular position of the lightguide 20 that is aligned with the position of the first opto-electronic component a test-light path can be established. This is exemplarily shown by a further angular position where the lightguide is directed to the first opto-electronic component 18.19.

A further advantageous effect of the sensor 10 according to the invention is that additional test-light paths T.X can be generated by allowing angular offset positions between the first coupling structure 22a and the first opto-electronic component 18.X. This means that the test-light path is generated by a first opto-electronic component 18.X illuminated at a time when the first coupling structure 22a has an angular offset to the illuminated first opto-electronic component. The generated test-light path is then oblique. According to this option a mesh of test-light paths can be created by solely synchronizing the activation of the first optical components with the angular position of the rotating mirror 12.

This allows for an increased number of test-light paths without being limited by spatial conditions. As explained in FIG. 1, the circular mirror 30 improves the level of energy that can be detected in such offset situations.

Furthermore, the beam shaping cavities 32 allow very spatially well-defined test-light paths, especially contributing to a better evaluation of the test-light paths generated via an offset constellation.

FIG. 2 shows the ring like lens 36 from a top view stretching over the sector of 270° covering all the first opto-electronic components 18.X.

The ring like lens 36 has the effect that the cone of the test-light beam TB in its extension in the cross-sectional plane including the rotation axis is narrowed, where it is not influenced to this extent in the circumferential direction.

FIG. 3a shows a further embodiment of the sensor 110 according to the invention in a schematic sideview.

The sensor 110 comprises a housing 140 that comprises a top cover 144, a lower cover 146 and a window having a first window element 142a and a second window element 142b. The first window element 142a and the second window element 142b are inclined relative to each other. The sensor 110 comprises a scanning unit 160 comprising a rotating mirror 112, a light emitter 114a and a light receiver 114b to scan the environment over a given angular detection range.

The sensor 110 according to the invention comprises a window monitoring unit 150 comprising a plurality of first opto-electronic components 118.1, 118.2, 118.3 118.4, 118.5, which are embodied as infrared LEDs.

Furthermore, the window monitoring unit 150 comprises a second opto-electronic component 116 embodied as a photodiode. The second opto-electronic component 116 is placed on the same circuit board 148 as the first opto-electronic components 118.X. The first opto-electronic components 118.X and the second opto-electronic component 116 are therefore attached to the housing 140 in a fixed position. Since neither the second opto-electronic component 116 nor the first opto-electronic components 118.X move during the operation of the sensor 110, they can easily be electrically connected to be measured by the sensor electronics (not shown).

Analogous to the description in FIG. 2, the first opto-electronic components 118.X are distributed around the circumference of the window 142b along the angular detection range alpha.

By way of example, the first opto-electronic component 118.1 emits a light beam which passes the second window 142b as well as the first window 142a following the test-light path T.10.

According to the invention, the window monitoring unit 160 comprises a lightguide 120 which is attached to the rotating mirror 112 in a way that it moves/rotates together with the rotating mirror 112. The lightguide 120 in this embodiment is a prism made of plastic having a first coupling structure 122a and a second coupling structure 122b. The lightguide 120 is embodied in a way that the first coupling structure 122a lies in a direction parallel to the rotation axis R of the rotating mirror 112. This means that light hitting the lightguide 220 in a direction that is basically parallel to the rotation axis R is coupled into the lightguide 120 and directed to the second coupling structure 122b. The test-light, which is basically emitted parallel to the rotation axis R from the first opto-electronic components 118.X, can be directly received by the lightguide 120.

The lightguide 120 is embodied in a way that the second coupling end 122b decouples the light in a direction that is also parallel to the rotation axis R.

In a further difference to the embodiment of FIG. 1, the second opto-electronic component 116 is not mounted aligned to the rotation axis R. According to this embodiment, the window monitoring unit 160 comprises a further lightguide 124 whose first coupling structure 126a is placed in alignment with the rotation axis R so that the test-light decoupling from the lightguide 120 at the second coupling structure 122b is led to the first coupling structure 126a of the further lightguide 124.

The test-light is then directed through the second lightguide 124 and led to the second coupling structure 126b where the test-light is decoupled from the lightguide 124 to illuminate the second opto-electronic component 116.

In a similar way to the arrangement of FIG. 1, the lightguide 120 may receive the test-light at all angular positions depending on the current rotation angle of the rotating mirror 112.

In contrast to the lightguide 20 of the arrangement in FIG. 1 the lightguide 120 comprises a lens-like structure at its first coupling structure 122a. This improves the reception properties for oblique test-light paths without using an additional mirror. Oblique test-light paths are generated when the angular position of the first opto-electronic component 118.X that is active and the position of the second coupling structure 122a of the lightguide 120 have an angular offset.

FIG. 3a exemplarily shows that the test-light emitted from the first-opto-electronic component 118.1 follows the path T.10. The test-light emitted from the first opto-electronic component 118.1 passes through the second window element 142b, then through the first window element 142a. After passing the window elements 142a, 142b, the test-light hits the first coupling structure 122a. The light is trapped in the lightguide 120 and led along the lightguide 120 to its second coupling structure 122b at the center of rotation of the rotating mirror 112. There, the test-light is extracted from the lightguide 120 and coupled into a further lightguide 124. The test-light is then received by the second opto-electronic component 116 being a photodiode. By using the additional lightguide 124 the second opto-electronic component 116 can be positioned more freely within the housing 144.

FIG. 3b shows the embodiment of FIG. 3a with the rotating mirror 112 in a different angular position, i.e., displaced by 90°, where the lightguide 120 lies in the according radial direction.

FIG. 3b shows that three test-light paths T.13, T.14, T.15 can be generated at a single angular position of the lightguide 120. One test-light path T.14 is generated by the first opto-electronic component 118.4 when it is directly below the first coupling structure 122a of the lightguide 120. The light-paths T.13 and T.15 are generated by the first opto-electronic component 118.3, 118.5 when the lightguide 120 is above the first opto-electronic component 118.4. Accordingly, test-light paths T.13, T.14 which pass through the window elements 142a, 142b in an oblique way are generated.

For a better understanding a further position of the lightguide 120′ having dashed lines is shown in FIG. 3b. In this angular position the test-light paths T.12′, T.13′ and T.14′ can be generated.

According to this example, it becomes clear that the resolution of light-paths penetrating the window elements can be increased and an easy and reliable connection of the opto-electronic components can still be maintained.

FIG. 4 shows a schematic view of the sensor 200 particularly showing the relevant parts of the window monitoring system, with the rotation axis, where the scanning parts of the sensor are, for the sake of clarity, not shown. Nevertheless, the rotation axis R is the rotation axis of the mirror (not shown) of a scanning device, where the mirror is driven by a motor 260.

The window monitoring unit comprises a second opto-electronic component 216 being a receiver, a lightguide 220 rotating around the rotation axis R and a plurality of first opto-electronic components 218.1, 218.2, 218.3, 218.4, 218.5, 218.5, . . . , 218.10 (also referred to as 218.X) where the first opto-electronic components 218.X are embodied as emitters, namely LEDs.

The window monitoring unit is preferably embodied in a way to acquire test-light along the test-light paths T.X of which at least a first test-light path T.25 is defined in such a way that it has a first offset between its angular position LP1 of the lightguide 220 and the active first opto-electronic component 218.5, and at least a second test-light path T.21 is defined in such a way that it has a second offset between its angular position LP4 of the lightguide and another active first opto-electronic component 218.1, where the second offset differs to the first offset by a defined lateral offset distance and/or in a lateral offset direction. In particular, crossing test-light paths T.21, T.25 are generated. Crossing test-light paths are generated if the position of the first active opto-electronic component 218.1 of a second light path T.21 comprises an offset to the first active opto-electronic 218.5 of a first light path 25 in a first offset direction and a first angular position LP.1 of the lightguide 220 of the first test-light path T.25 and the second angular position LP.4 of the light-guide of the second test-light path T.21 comprises a second offset, where the second offset direction is opposite to the first offset direction. Due to this setup a so called shadowing effect can be avoided as cross information is gained.

To acquire the information over the optical mesh, the evaluation unit 250 activates the first opto-electronic components, which are in this example particularly LEDs, to emit a pulsed test-light to establish a test-light path via the lightguide 220 at its current angular position LP.X that is then received by the single receiver 216.

The current angular position LP.X is known by the evaluation unit 250, as the angular position of the mirror (not shown) and accordingly the position of the lightguide 220 attached to the mirror which rotates around the rotation axis R is easily derivable, particularly from the motor 260, more particularly its controller. Depending on the angular position LP.X and the position of the emitting first active opto-electronic component 218.X a specific test-light path T.X can be generated. Due to the synchronization of the activation of the first opto-electronic components with the angular position of the lightguide 220, the window monitoring unit 210 is designed to acquire the intensities of a plurality of light paths especially including a plurality of crossing light paths e.g. T.21, T.25.

Due to evaluating a plurality of such test-light paths T.X, an optical mesh of test-light paths T.X is generated, which due to the relatively small size of the lightguide can have a very high resolution, as a much more distinct angular position LP.X can be realised than by using separate receivers for each position.

According to the invention, detailed information based on a very close-meshed optical mesh can be gained. Accordingly, due to the detailed information gained, an improved evaluation of a position and the size of spots polluting the window can be executed.

The optical mesh is generated in a way that the test-light paths are generated subsequently, preferably one at a time, where the evaluation unit evaluates the transparency of the window after all the test-light paths belonging to the optical mesh have been measured.

The improved determination of the change of transparency of the window allows the behaviour of the scanning unit to be influenced in a more differentiated manner and depending on which window element the spot occurs, a specific action can be chosen. Hence, e.g., it could be avoided to unnecessarily shut down the sensor.

### LIST OF REFERENCE SIGNS

10 sensor
12 rotating mirror
14a scanning-light emitter
14b scanning-light receiver
15a scanning-light emitter
15b scanning-light receiver
16 second opto-electronic component
18 first opto-electronic component
20 lightguide
22a first coupling structure
22b second coupling structure
26 window monitoring unit
28 shielding
30 circular mirror
32 conical cavity
36 lens
40 housing
42a first window element
42b second window element
44 top cover
46 lower cover
50 window monitoring unit
60 scanning unit
110 sensor
112 rotating mirror
114a emitter
114b receiver
116 second opto-electronic component
118.X first opto-electronic component
120 lightguide
122a first coupling structure
122b second coupling structure
124 further lightguide
126a first coupling structure
126b second coupling structure
140 housing
142a first window element
142b second window element
144 top cover
146 lower cover
148 circuit board
150 window monitoring unit
160 scanning unit
200 sensor
210 window monitoring unit
216 second opto-electronic component
218.X first opto-electronic component
220 lightguide
250 evaluation unit
260 motor
alpha angular scanning range
R rotation axis
SE emitted scanning-light
SR received scanning-light
T.X test-light path
TB test-light beam
LP.X angular position of the lightguide

1-19 (canceled)

20. A sensor (10), comprising
a housing (40), wherein the housing (40) comprises a window (42a, 42b) that extends over an angular detection range (alpha) and through which a scanning-light (SE, SR) can pass,
a scanning unit (60) placed inside the housing (40) to scan the angular detection range (alpha) by emitting and receiving the scanning-light (SE, SR), wherein the scanning unit (60) comprises a rotating mirror (12) to deflect emitting and receiving the scanning-light (SE, SR), and
a window monitoring unit (50) to detect pollution on the window (42a, 42b), where the window monitoring unit (50) comprises at least a first opto-electronic component (18.1, . . . ,18.22) and a second opto-electronic component (16) between which a test-light path (T.1, T.2, T.3 . . . ) is established by sending test-light from the first opto-electronic component (18.X) to the second opto-electronic component (16) or vice-versa,
wherein the test-light path (T.X) passes through the window (42a, 42b), and furthermore, the window monitoring unit (50) comprises an optical component through which the test-light can be redirected,
the first opto-electronic component (18.1, . . . ,18.22) and the second opto-electronic component (16) are attached to the housing (40),
the opto-electronic components (18.1, . . . , 18.22; 16) and the optical component are arranged in a way that a plurality of test-light paths (T.X) can be generated along the angular detection range (alpha) of the scanning unit (60) characterized in that the optical component is a lightguide (20) that guides the test-light between the at least one first opto-electronic component (18.1, . . . ,18.22) and the at least one second opto-electronic component (16), and
the lightguide (20) is attached to the rotating mirror (12) in a way that it rotates together with the rotating mirror (12), so that test-light paths (T.X) of different angular positions end at the at least one same second opto-electronic component (16).

21. The sensor according to claim 20, wherein the window monitoring unit (50) comprises a plurality of first opto-electronic components (18.1, . . . ,18.22) and a single second opto-electronic component (16) to establish a plurality of test-light paths (T.X).

22. The sensor according to claim 20, wherein the lightguide (20) comprises a second coupling structure (22b) at the center of rotation of the rotating mirror (12) to couple or decouple light of different light-paths to the second opto-electronic component (16).

23. The sensor according to claim 20, wherein the lightguide (20) is a fibre or a prism or channel.

24. The sensor according to claim 23, wherein the lightguide (20) is a prism and the coupling structure is established by an inclined surface.

25. The sensor according to claim 22, wherein the second opto-electronic component (16) is positioned in alignment with the axis of rotation (R) of the rotating mirror (12).

26. The sensor according to claim 22, wherein the window monitoring unit (150) comprises an additional lightguide (124) to guide the light to a second opto-electronic component (116) where the first coupling structure (126a) is positioned in alignment with the axis of rotation (R) of the rotating mirror (112).

27. The sensor according to claim 20, wherein the second opto-electronic component (16) is a light-receiver, especially a photodiode.

28. The sensor according to claim 25, wherein there is a plurality of first opto-electronic components (18.X) being emitters, namely LEDs distributed over the angular detection range parallel to the contour of the window (42a, 42b).

29. The sensor according to claim 20, wherein the window monitoring unit (50) comprises a circular mirror (30) at about the height of the lightguide (20), where the circular mirror (30) deflects the test-light between the first opto-electronic component (16) and the lightguide (20).

30. The sensor according to claim 28, wherein said window monitoring unit (50) comprises a shielding (28) that surrounds a plurality of first opto-electronic components (18.1, . . . ,18.22) where the shielding (28) comprises a conical cavity (32) around each of the plurality of the first opto-electronic components (18.1, . . . ,18.22).

31. The sensor according to claim 20, wherein the window comprises two window elements (42a, 42b) that are tilted relative to each other and where the two window elements (42a, 42b) are placed above one another in an axial view as seen along the rotation axis (R) of the rotating mirror (12).

32. The sensor according to claim 31, wherein the two window elements (42a, 42b) are optically separated to reduce crosstalk between the emitted scanning-light (SE) and the received scanning-light (SR).

33. The sensor according to claim 31, wherein the window monitoring unit (50) is embodied in a way that the test-light passes through both window elements (42a, 42b).

34. The sensor according to claim 20, wherein there is at least one lens between the at least one first opto-electronic component (18.X, 118.X, 218.X) and the lightguide (20, 120, 220) where the lens (36) is embodied as a converging lens having its focal point close to the first opto-electronic component (18.X, 118.X, 218.X).

35. The sensor according to claim 34, wherein in circumferential direction, the lens (36) has a ringlike shape of circle or a sector of a circle and stretches over at least a part of the angular detection range (alpha).

36. The Sensor according to claim 20, wherein an evaluation unit (250) is embodied in a way to acquire test light along the test-light paths (T.X) of which at least a first light path (T14, T21) is defined in such a way that it has a first offset between its angular position of the lightguide (20, 120, 220) and the active first opto-electronic component (18.X, 118 X.218.X), and at least a second light path (T14′, T25) is defined in such a way that it has a second angular offset between the angular position (LP.X) of the lightguide and an active first opto-electronic component (18.X, 118.X, 218.X), where the second offset differs to the first offset by a defined angular offset distance and/or in an angular offset direction.

37. The sensor according to claim 36, wherein the evaluation unit (250) is designed to acquire intensities of a plurality of crossing light paths (T.13, T.14′; T.21, T.25) to evaluate an optical mesh of light paths.

38. A method to determine the transparency of a window of the sensor as described in claim 20, where the sensor (10, 200) comprises
a window having a first window element (42a, 242a),
a second window element (42b, 242b), and
an evaluation unit (250),
wherein the angular position of the lightguide (20, 220) and the activation of the first opto-electronic component (18.x, 118.X, 218.X) and/or the second opto-electronic (16, 116, 216) component are synchronized in a way that an optical mesh of test-light paths is established and the optical mesh is evaluated based on the measured intensities related to the test-light paths (T.X), and
a change of transparency of the window is determined to be on the first window element (42a, 242a) and/or the second window element (42b, 242b).
